(19) United States
(12) Patent Application Publication
(10) Pub. No.: US 2024/0120815 A1
(43) Pub. Date: Apr. 11, 2024

(54) MAGNET FIXING METHOD AND MAGNET FIXING APPARATUS

(71) Applicant: TOYOTA BOSHOKU KABUSHIKI KAISHA, Aichi-ken (JP)

(72) Inventors: Masaki SUGIYAMA, Okazaki-shi (JP); Hiroshi AIHARA, Toyota-shi (JP); Hiroki MORITA, Nagoya-shi (JP)

(73) Assignee: TOYOTA BOSHOKU KABUSHIKI KAISHA, Aichi-ken (JP)

(21) Appl. No.: 18/376,649

(22) Filed: Oct. 4, 2023

(30) Foreign Application Priority Data
Oct. 11, 2022 (JP) 2022-163093

(51) Int. Cl. H02K 15/03; H02K 1/276; H02K 1/28; H02K 15/12

(52) U.S. Cl. CPC H02K 15/03; H02K 1/276; H02K 1/28; H02K 15/12

(57) ABSTRACT

A magnet fixing method includes heating a rotor core. The magnet fixing method also includes inserting one or more of magnets, to which fixing sheets are bonded, into the uppermost one or more of slots with the rotor core being rotatably supported by a rotating jig such that openings of the slots face sideways. The magnet fixing method also includes fixing each magnet to the corresponding slot by heating a foam layer to foam the foam layer. The inserting one or more of magnets includes inserting the magnets into all the slots by repeating insertion of one or more of the magnets into the corresponding one or more of the slots with the associated one or more of the fixing sheets facing upward, and rotation of the rotor core.

### BACKGROUND

### 1. Field

The present disclosure relates to a magnet fixing method and a magnet fixing apparatus.

### 2. Description of Related Art

A typical rotor forming a rotating electric machine includes a rotor core and permanent magnets (hereinafter, referred to as magnets). The rotor core is formed by stacking core pieces. The magnets are inserted in slots in the rotor core and fixed to the slots.

The above-described typical rotor includes foamed bonding sheets each arranged between the magnet and an inner surface of the slot. The foamed bonding sheet includes a foam layer and a bonding layer, which are stacked together. The foam layer is in tight contact with and fixed to the magnet. The bonding layer faces the inner surface of the slot.

In a typical method of manufacturing the above-described typical rotor, first, a magnet assembly, in which the foamed bonding sheet is in tight contact with and fixed to the magnet, is inserted into each slot. Subsequently, the magnet assemblies are heated so that the foam layers are foamed. As a result, the bonding layers are in tight contact with the slots so that the magnets are fixed to the slots.

In the above-described typical method of manufacturing the rotor, the bonding layer is likely to contact the inner surface of the slot in the process of inserting the magnet assembly into the slot. Thus, there is room for improvement in smoothness of insertion of the magnets.

Further, in the above-described typical method of manufacturing the rotor, the magnet assemblies are heated after the magnet assemblies are inserted in all the slots. Therefore, there is naturally a limit to shortening the time from the start of insertion of the magnet assemblies to the completion of fixation of the magnets to the slots.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a magnet fixing method of inserting magnets to which fixing sheets are bonded into slots of a rotor core formed by stacking core pieces and fixing the magnets to the slots with the fixing sheets in between is provided. Each fixing sheet includes a foam layer that is bonded to a surface of the corresponding magnet and is foamed when heated. The magnet fixing method includes heating the rotor core. The magnet fixing method also includes inserting one or more of the magnets, to which the fixing sheets are bonded, into uppermost one or more of the slots with the rotor core being rotatably supported by a rotating jig such that openings of the slots face sideways. The magnet fixing method also includes fixing each magnet to the corresponding slot by heating the associated foam layer to foam the foam layer. The inserting one or more of the magnets includes inserting the magnets into all the slots by repeating insertion of one or more of the magnets into the corresponding one or more of the slots with the associated one or more of the fixing sheets facing upward, and rotation of the rotor core.

In another general aspect, a magnet fixing apparatus is configured to insert magnets to which fixing sheets are bonded into slots of a rotor core formed by stacking core pieces and to fix the magnets to the slots with the fixing sheets in between. Each fixing sheet includes a foam layer that is bonded to a surface of the corresponding magnet and is foamed when heated. The magnet fixing apparatus includes a heating device, a rotating jig, a guide member, and a push mechanism. The heating device is configured to heat the rotor core. The rotating jig is configured to rotatably support the rotor core such that openings of the slots face sideways. The guide member includes a guiding surface. The guiding surface extends along an axis of the rotor core and is configured to contact a lower surface of the magnet and guide the magnet toward the corresponding slot. The push mechanism is configured to push the magnet on the guiding surface into the corresponding slot.

Other features and aspects will be apparent from the following detailed description, the drawings, and the claims.

### BRIEF DESCRIPTION OF THE DRAWINGS

FIG. 1A is a front view of a rotor according to one embodiment.

FIG. 1B is a side view of the rotor.

FIG. 2 is a partially enlarged view of FIG. 1A.

FIG. 3 is a cross-sectional view of a fixing sheet forming the rotor shown in FIG. 1A before being foamed.

FIG. 4 is a schematic diagram of a magnet fixing apparatus according to one embodiment.

FIG. 5 is a schematic diagram of a bonding step.

FIG. 6 is a cross-sectional view showing an inserting step.

FIG. 7 is a cross-sectional view taken along line 7-7 of FIG. 6.

FIG. 8 is a cross-sectional view showing a fixing step.

FIG. 9 is a cross-sectional view taken along line 9-9 of FIG. 6, illustrating a guide member according to a modification.

FIG. 10 is an enlarged cross-sectional view illustrating a guiding surface of a guide member according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

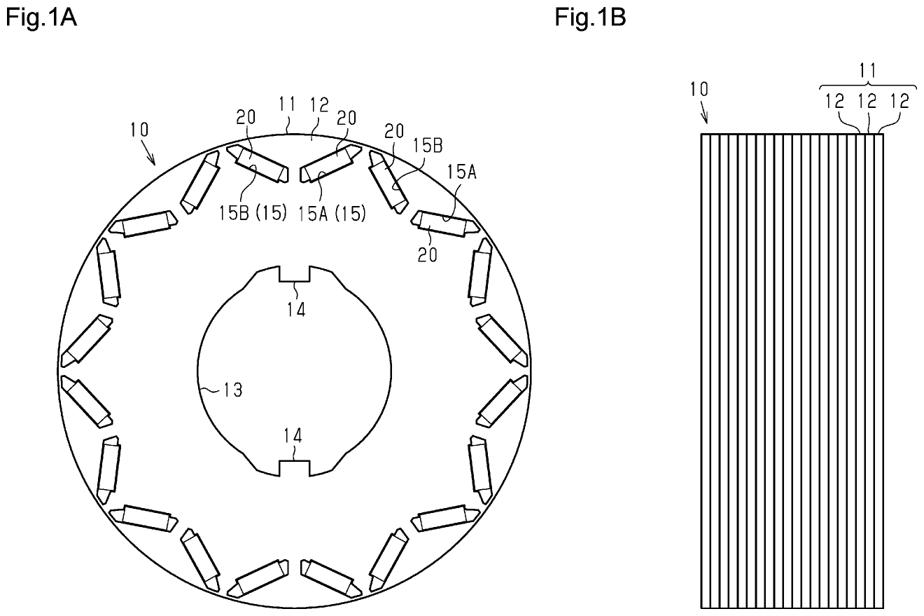

A magnet fixing method and a magnet fixing apparatus according to one embodiment will now be described with reference to FIGS. 1A to 8.

First, the structure of a rotor 10 will be described.

In the following description, an axial direction, a radial direction, and a circumferential direction of the rotor 10 will simply be referred to as the axial direction, the radial direction, and the circumferential direction, respectively.

Rotor 10

As shown in FIG. 1A, a rotor core 11 includes a center hole 13 and slots 15. The center hole 13 and the slots 15 extend through the rotor core 11 in the axial direction.

The center hole 13 includes two keys 14, which protrude radially inward. The two keys 14 face in the radial direction.

The slots 15 are arranged in a row in the circumferential direction.

The slots 15 of the present embodiment include slots 15A, which, when viewed from the front, extend outward in the radial direction toward the front side in a clockwise direction, and slots 15B, which, when viewed from the front, extend inward in the radial direction toward the front side in the clockwise direction. In the present embodiment, the slots 15A and the slots 15B are arranged alternately in the circumferential direction.

As shown in FIG. 1B, the rotor 10 includes the rotor core 11, which is formed by stacking core pieces 12. Each core piece 12 is made of a magnetic steel sheet.

Each core piece 12 includes dimples (not shown) that bulge toward one side in the axial direction. The core pieces 12 adjacent to each other are coupled together by press-fitting dimples in one of the core pieces 12 into the dimples in the other core piece 12.

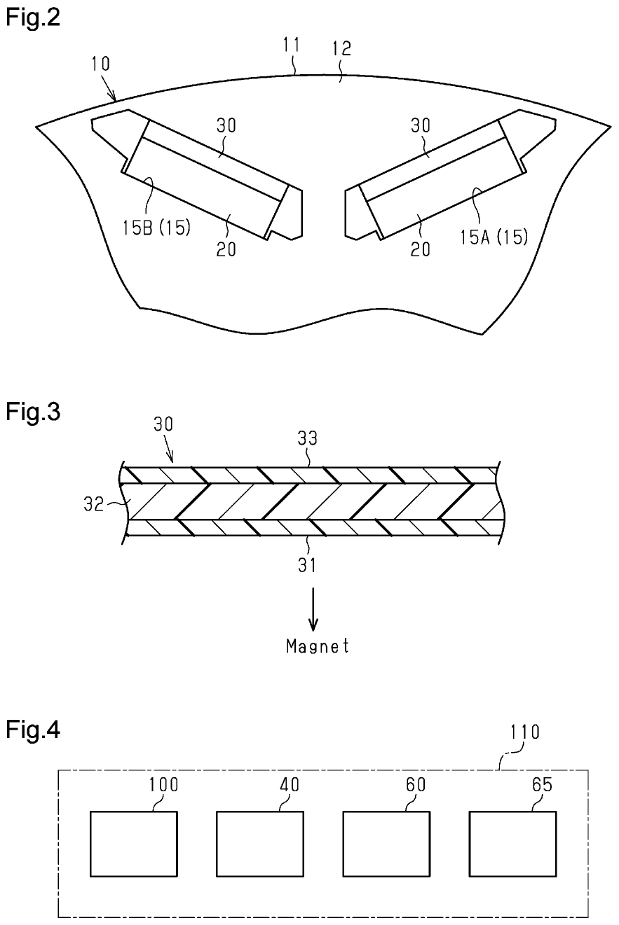

As shown in FIG. 2, magnets 20, to which fixing sheets 30 are bonded, are inserted into the slots 15. Each magnet 20 is fixed to the corresponding slot 15 with the fixing sheet 30 in between.

Each magnet 20 is a rectangular parallelepiped permanent magnet.

As shown in FIG. 3, the fixing sheet 30 includes an inner bonding layer 31, a foam layer 32, and an outer bonding layer 33.

The inner bonding layer 31 is bonded to a surface of the magnet 20. The inner bonding layer 31 has a bonding property at room temperature. The inner bonding layer 31 is made of, for example, a thermoplastic. The inner bonding layer 31 may be made of a thermosetting plastic.

The foam layer 32 is formed on a surface of the inner bonding layer 31 located on the opposite side from the magnet 20. The foam layer 32 is made of a foam material that is foamed when heated. The foam material is preferably urethane.

The outer bonding layer 33 is a layer formed on a surface of the foam layer 32 on the opposite side from the inner bonding layer 31. The outer bonding layer 33 exhibits a bonding property when heated. The outer bonding layer 33 is preferably made of a thermoplastic.

A method of fixing the magnets 20 according to the present embodiment will now be described.

The method of fixing the magnets 20 includes a bonding step, a heating step, an inserting step, and a fixing step. In the present embodiment, a magnet fixing apparatus 110 is used in the heating step, the inserting step, and the fixing step. As shown in FIG. 4, the magnet fixing apparatus 110 includes a heating device 100, a rotating jig 40, a guide member 60, and a push mechanism 65.

The bonding step of bonding the fixing sheet 30 to the surface of each magnet 20 will now be described.

Bonding Step

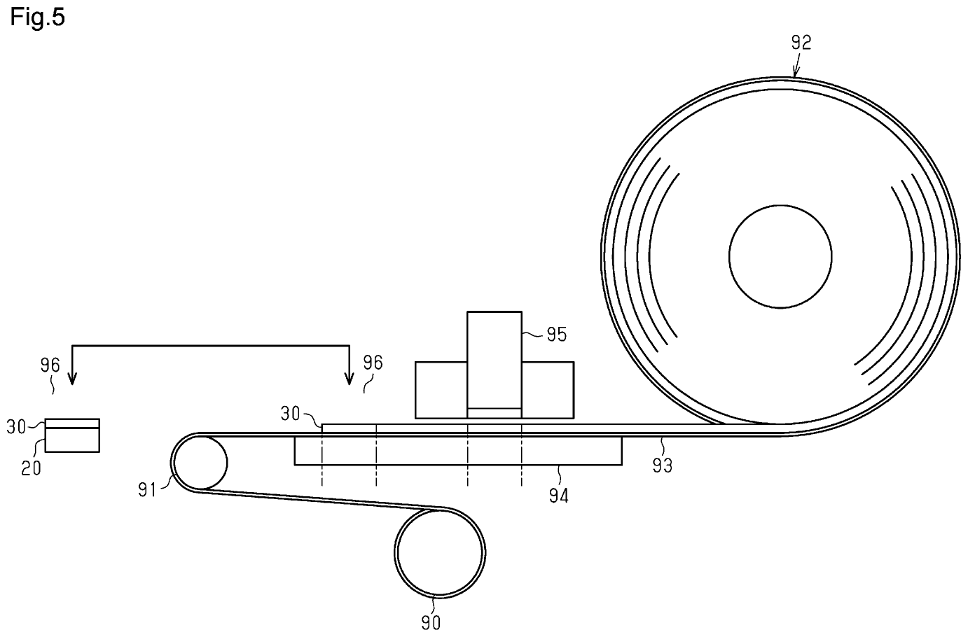

As shown in FIG. 5, in the bonding step, a release sheet 93 of a fixing sheet roll 92 is intermittently wound up by a take-up roller 90 through a roller 91. In the bonding step, rectangular shaped cuts are formed in the fixing sheet 30 being conveyed on a platform 94.

The fixing sheet roll 92 is formed by the band-shaped release sheet 93 and a band-shaped fixing sheet 30, which is releasably bonded to the release sheet 93 with the inner bonding layer 31 in between.

A cutter 95 is located above the platform 94 to be lifted and lowered. The cutter 95 is lowered to be pressed against the fixing sheet 30 on the platform 94, so that a cut is formed in the fixing sheet 30.

Subsequently, the portion of the fixing sheet 30 enclosed by the cut is suctioned by a suction plate 96. A moving device (not shown) then moves the suction plate 96 toward one surface of a magnet 20. The moving device presses the inner bonding layer 31 of the fixing sheet 30 against the surface of the magnet 20, thereby bonding the fixing sheet 30 to the surface of the magnet 20.

Heating Step

In the heating step, the rotor core 11 is heated by the heating device 100. The heating device 100 has a known configuration such as an electric furnace. The temperature of the rotor core 11 is, for example, higher than or equal to the temperature at which the foam layer 32 of the fixing sheet 30 starts being foamed.

Inserting Step

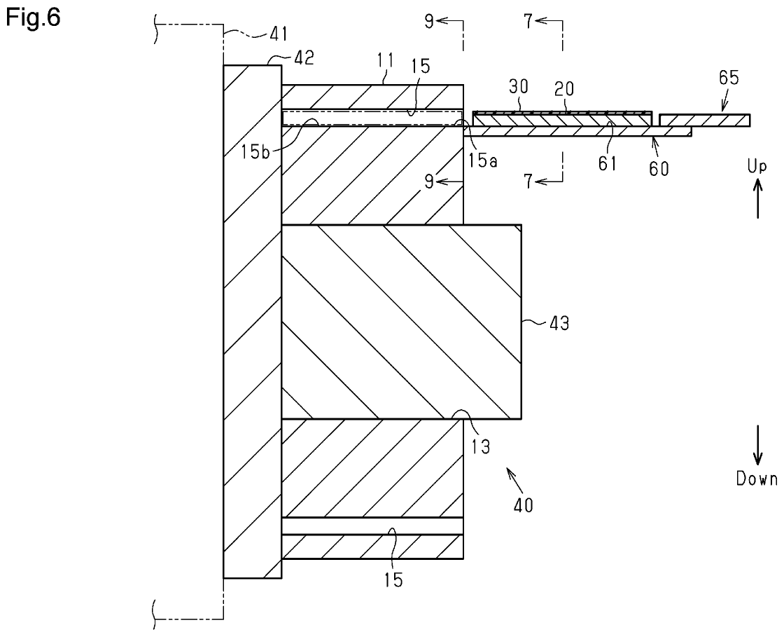

As shown in FIG. 6, in the inserting step, the rotating jig 40 first rotatably supports the rotor core 11 such that openings 15a of the slots 15 face sideways.

The rotating jig 40 includes a main body 41, a plate 42, and a post 43. The plate 42 is rotatably coupled to the main body 41 and supports the end face on one side of the rotor core 11. The post 43 protrudes from the plate 42 and extends through the center hole 13 of the rotor core 11. The main body 41 is configured to rotate the plate 42 and the post 43 about the axis of the post 43.

The plate 42 is preferably sized to contact the entire end face on one side of the rotor core 11.

The post 43 includes two keyways 44 on the outer circumferential surface. The keyways 44 are engaged with the two keys 14 of the rotor core 11 (see FIG. 8).

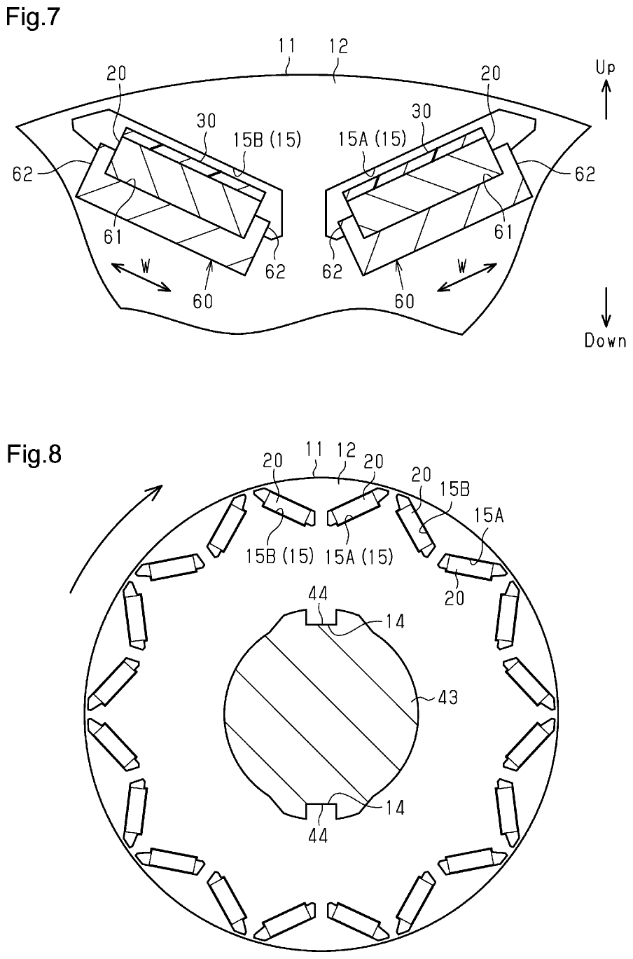

Subsequently, as shown in FIGS. 6 and 7, a magnet 20 to which the fixing sheet 30 is bonded is inserted into the uppermost one of the slots 15.

As shown in FIG. 7, in the present embodiment, two magnets 20 to which the fixing sheets 30 are bonded are respectively inserted into uppermost two slots 15A, 15B among the slots 15.

As shown in FIG. 6, insertion of a magnet 20 is performed by using a guide member 60 and a push mechanism 65. In the present embodiment, two magnets 20 are inserted into two slots 15A, 15B by two guide members 60 and two push mechanisms 65.

The guide member 60 includes a guiding surface 61. The guiding surface 61 extends along the axis of the rotor core 11 and contacts the lower surface of a magnet 20 to guide the magnet 20 toward the uppermost one of the slots 15.

In the present embodiment, the distal end face of the guide member 60 contacts the end face of the rotor core 11.

The guiding surface 61 is located on the same plane as a bottom surface 15b of a slot 15, that is, as the inner surface with which the magnet 20 inserted into the slot 15 comes into contact.

In the present embodiment, the uppermost two slots 15A, 15B extend radially inward as the uppermost two slots 15A, 15B extend toward each other in the circumferential direction (refer to FIG. 2).

As shown in FIG. 7, two guiding surfaces 61 that respectively correspond to the two slots 15A, 15B extend radially inward as the two slots 15A, 15B extend toward each other in the circumferential direction.

Each guide member 60 includes two restriction walls 62, which extend upright from opposite ends in a width direction W of the guiding surface 61. The two restriction walls 62 are configured to contact the magnet 20 to restrict movement of the magnet 20 in the width direction W.

The two restriction walls 62 are preferably provided over the entire guide member 60 in the extending direction.

The guide member 60 is preferably made of a material having a low thermal conductivity and a low linear expansion coefficient, such as a ceramic.

The push mechanism 65 is configured to push an end face in the axial direction of each magnet 20 on the guiding surface 61 into one of the slots 15.

In the inserting step, each magnet 20 is inserted into one of the slots 15 with the fixing sheet 30 facing upward. The rotor core 11 is repeatedly rotated, so that the magnets 20 are inserted into all the slots 15.

Fixing Step

In the fixing step, the foam layers 32 are heated to be foamed, so that the magnets 20 are fixed to the slots 15 as shown in FIG. 8.

In the present embodiment, after the inserting step, the rotating jig 40 is used to rotate the rotor core 11 such that each fixing sheet 30 is pressed against the inner surface of the corresponding slot 15 by applying centrifugal force to the magnets 20.

Operation of the present embodiment will now be described.

The rotating jig 40 supports the rotor core 11 such that the rotor core 11 is heated and the openings 15a of the slots 15 face sideways. In this state, magnets 20, to which fixing sheets 30 are bonded, are inserted into the uppermost two of the slots 15. Thereafter, when the rotor core 11 is rotated by the rotating jig 40 so that centrifugal force acts on each magnet 20 to press each fixing sheet 30 against the inner surface of the corresponding slot 15, the outer bonding layer 33 and the foam layer 32 are heated by heat transfer from the inner surface of the slot 15. This allows the outer bonding layer 33 to exhibit a bonding property and foams the foam layer 32. The anchoring effect is caused by the fixing sheet 30 entering gaps between the core pieces 12, so that the magnet 20 is fixed to the slot 15.

According to the present embodiment, since each magnet 20 is inserted into the corresponding slot 15 while the lower surface of the magnet 20 is in contact with the inner surface of the slot 15 with the fixing sheet 30 facing upward, the fixing sheet 30 is less likely to be in contact with the heated inner surface of the slot 15. This prevents the foam layer 32 from starting to be foamed by heat transfer from the inner surface of the slot 15 during insertion of the magnet 20. This improves smoothness of insertion of the magnet 20.

Also, compared to a case in which the rotor core 11 starts being heated after the magnets 20 are inserted in the slots 15, the present embodiment shortens the time required from the start of the inserting step to the completion of the fixing step.

The present embodiment has the following advantages.
(1) In the inserting step, each magnet 20 is inserted into one of the slots 15 with the fixing sheet 30 facing upward, and the rotor core 11 is repeatedly rotated, so that the magnets 20 are inserted into all the slots 15.

Since this method operates in the above-described manner, the magnet fixing is performed efficiently.
(2) In the fixing step, the rotating jig 40 is used to rotate the rotor core 11 such that each fixing sheet 30 is pressed against the inner surface of the corresponding slot 15 by applying centrifugal force to the magnets 20 after the inserting step.

With this method, the fixing sheets 30 are pressed against the inner surfaces of the slots 15 by the centrifugal force acting on the magnets 20. Thus, the foam layers 32 are heated by the heat transfer from the inner surfaces of the slots 15, which promotes foaming of the foam layers 32. This allows the fixing of the magnets 20 to the slots 15 to be completed at an early stage.
(3) The magnet fixing apparatus 110 includes the heating device 100, which heats the rotor core 11, and the rotating jig 40, which rotatably supports the rotor core 11 such that the openings 15a of the slots 15 face sideways. The magnet fixing apparatus 110 also includes the guide members 60. The guide members 60 respectively include the guiding surfaces 61, which extend along the axis of the rotor core 11 and contact the lower surfaces of the magnets 20 to guide the magnets 20 into the uppermost ones of the slots 15. The magnet fixing apparatus 110 also includes the push mechanisms 65, which push magnets 20 on the guiding surfaces 61 into the corresponding slots 15.

This configuration has an advantage similar to the above-described advantage (1).
(4) Each guide member 60 includes two restriction walls 62, which extend upright from opposite ends in a width direction W of the guiding surface 61.

With this configuration, since the two restriction walls 62 restrict movement of the magnet 20 in the width direction W, the magnet 20 is easily inserted into the slot 15 in the extending direction of the slot 15.
(5) Each of the guide members 60 is made of a ceramic.

When performing insertion of a magnet 20 with the distal end face of the guide member 60 brought into contact with the end face of the rotor core 11, the guide member 60 is heated by heat transfer from the heated rotor core 11, and the foam layer 32 is heated by the magnet 20 contacting the guiding surface 61. In this case, the magnet 20 may be prevented from being smoothly inserted if the foam layer 32 is foamed before or during the insertion of the magnet 20.

In this respect, since the thermal conductivity and the linear expansion coefficient of the guide member 60 are relatively low in the above-described configuration, the guide member 60 is less likely to be thermally expanded by the heat transfer from the rotor core 11 to the guide member 60, and the heat of the rotor core 11 is less likely to be transferred to the fixing sheet 30 via the magnet 20. Therefore, before or during insertion of the magnet 20, the foam layer 32 is prevented from starting to be foamed by heat transfer from the guide member 60. This improves smoothness of insertion of the magnet 20.

<Modifications>

The above-described embodiment may be modified as follows. The above-described embodiment and the following modifications can be combined as long as the combined modifications remain technically consistent with each other.

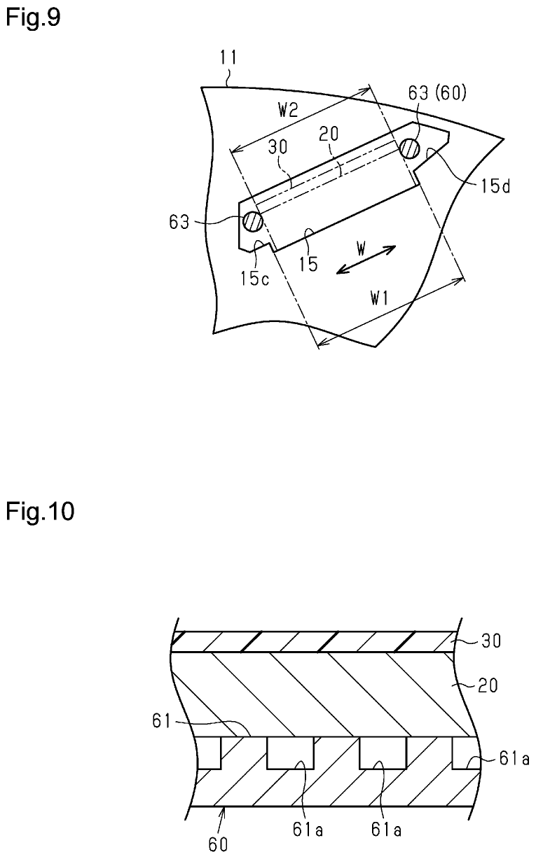

As shown in FIG. 9, the guide member 60 may include two restriction pins 63, which can be received by two pocket portions 15c and 15d, which are formed at opposite ends in the width direction W of the slot 15. The restriction pins 63 are configured to contact the magnet 20 to restrict movement of the magnet 20 in the width direction W. The two restriction pins 63 are coupled to, for example, the distal end face of the restriction wall 62.

A width W1 of a section of each slot 15 into which a magnet 20 is insertable is set to be greater than a width W2 of the magnet 20. The magnet 20 thus can be tilted inside the slot 15.

In this regard, the above-described configuration allows the guide member 60 to advance toward the slot 15 so that the two restriction pins 63 are received by the pocket portions 15c, 15d. The insertion of the magnet 20 in this state allows the two restriction pins 63 to restrict movement of the magnet 20 in the width direction W. This restricts tilting of the magnet 20 inside the slot 15.

As shown in FIG. 10, recesses 61a may be provided in the guiding surface 61 of each guide member 60. In this case, the recesses 61a in the guiding surface 61 reduce the area of contact between the guiding surface 61 and the magnet 20.

A great number of recesses 61a as shown in FIG. 10 reduce the sliding resistance of the magnet 20 when the magnet 20 slides on the guiding surface 61. This facilitates insertion of the magnet 20 into the slot 15.

As described above, when performing insertion of a magnet 20 with the distal end face of the guide member 60 brought into contact with the end face of the rotor core 11, the guide member 60 is heated by heat transfer from the heated rotor core 11, and the foam layer 32 is heated by the magnet 20 contacting the guiding surface 61. In this case, the magnet 20 may be prevented from being smoothly inserted if the foam layer 32 is foamed before or during the insertion of the magnet 20.

In this regard, according to the above-described configuration, the contact area between the guiding surface 61 and the magnet 20 is reduced, so that heat transfer from the guiding surface 61 to the magnet 20 is restricted. This prevents the above-described disadvantages from occurring.

The two restriction walls 62 may be omitted from the guide member 60.

The distal end of the guiding surface 61 of the guide member 60 may be inserted into each slot 15.

After the inserting step, the rotor core 11 does not necessarily need to be rotated by the rotating jig 40. Even in this case, the heat transferred from the rotor core 11 through the magnets 20 heats and foams the foam layers 32.

The fixing sheet 30 is not limited to the one that includes the outer bonding layer 33, and the outer bonding layer 33 may be omitted. Even in this case, the anchoring effect is caused by the foam layer 32 entering gaps between the core pieces 12, so that the magnet 20 is fixed to the slot 15.

The rotor core 11 may be supported by the rotating jig 40 such that a magnet 20 is inclined to descend toward the leading end in the insertion direction of the magnet 20. Since some of the gravity acting on the magnet 20 acts toward the leading side in the insertion direction, the magnet 20 can be pushed into the slot 15 by a relatively small force.

The rotating jig 40 may be provided with a post 43 with an adjustable outer diameter. When the rotor core 11 is heated and thermally expanded, the inner diameter of the center hole 13 is greater than that at room temperature. For this reason, after the fixing step, it may become difficult to remove the rotor 10 from the rotating jig 40 due to the center hole 13 of the rotor 10 shrinking when cooled and thermally contracted. In this regard, since the above-described configuration allows the outer diameter of the post 43 to be reduced, the rotor 10 is readily removed from the rotating jig 40.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A magnet fixing method of inserting magnets to which fixing sheets are bonded into slots of a rotor core formed by stacking core pieces and fixing the magnets to the slots with the fixing sheets in between, each fixing sheet including a foam layer that is bonded to a surface of the corresponding magnet and is foamed when heated, the magnet fixing method comprising:
heating the rotor core;
inserting one or more of the magnets, to which the fixing sheets are bonded, into uppermost one or more of the slots with the rotor core being rotatably supported by a rotating jig such that openings of the slots face sideways; and
fixing each magnet to the corresponding slot by heating the associated foam layer to foam the foam layer, wherein
the inserting one or more of the magnets includes inserting the magnets into all the slots by repeating:
insertion of one or more of the magnets into the corresponding one or more of the slots with the associated one or more of the fixing sheets facing upward; and
rotation of the rotor core.

2. The magnet fixing method according to claim 1, wherein the fixing each magnet to the corresponding slot includes rotating the rotor core, in which the magnets are inserted into all the slots, with the rotating jig to apply a centrifugal force to each of the magnets, thereby pressing each fixing sheet against an inner surface of the corresponding slot.

3. A magnet fixing apparatus configured to insert magnets to which fixing sheets are bonded into slots of a rotor core formed by stacking core pieces and to fix the magnets to the slots with the fixing sheets in between, each fixing sheet including a foam layer that is bonded to a surface of the corresponding magnet and is foamed when heated, the magnet fixing apparatus comprising:
a heating device configured to heat the rotor core;
a rotating jig configured to rotatably support the rotor core such that openings of the slots face sideways;
a guide member including a guiding surface, the guiding surface extending along an axis of the rotor core and being configured to contact a lower surface of the magnet and guide the magnet toward the corresponding slot; and
a push mechanism configured to push the magnet on the guiding surface into the corresponding slot.

4. The magnet fixing apparatus according to claim 3, wherein
the guide member includes two restriction walls that extend upright from opposite ends in a width direction of the guiding surface, and
the two restriction walls are configured to contact the magnet to restrict movement of the magnet in the width direction.

5. The magnet fixing apparatus according to claim 3, wherein
the guide member includes two restriction pins that are respectively insertable into two pocket portions formed at opposite ends in a width direction of each slot, and
the restriction pins are configured to contact the magnet to restrict movement of the magnet in the width direction of the slot.

6. The magnet fixing apparatus according to claim 3, wherein a recess is formed in the guiding surface.
